(19) United States
(12) Patent Application Publication
(10) Pub. No.: US 2020/0311611 A1
(43) Pub. Date: Oct. 1, 2020

(54) FEATURE GENERATION AND FEATURE SELECTION FOR MACHINE LEARNING TOOL

(71) Applicant: CASEWARE INTERNATIONAL INC., Toronto (CA)

(72) Inventor: BRETT KENNEDY, TORONTO (CA)

(73) Assignee: CASEWARE INTERNATIONAL INC.

(21) Appl. No.: 16/365,622

(22) Filed: Mar. 26, 2019

(51) Int. Cl. G06N 20/20; G06F 11/36; G06F 11/34

(52) U.S. Cl. CPC G06N 20/20; G06F 11/3466; G06F 11/3696

(57) ABSTRACT

A machine learning model is trained by receiving an input data set comprising a plurality of data elements having base features and automatically generating a plurality of synthetic features. Synthetic features are derived by applying at least one mathematical function to at least one existing base or synthetic feature. A feature score is determined for each feature and is representative of a correlation with a target characteristic. A filtered subset is selected from base and synthetic features based on the feature score values. The selected features are provided to the machine learning tool and the input data set is provided to said machine learning tool to generate said model.

### FIELD

This disclosure relates to machine learning, and particularly to automatic generation of features for training models using machine learning.

### BACKGROUND

Machine learning tools are regularly used to predict to characteristics of data elements. Generally, machine learning tools may seek to predict the value of one or more variables associated with a data element. The variables may be referred to as targets. Targets may be binary, e.g. whether a particular data element belongs to a given category, non-binary categorical (e.g. identifying a category to which a data element belongs), or continuous.

Such machine learning tools are typically initialized using a large set of labeled data elements (referred to as “training”). Each data element in the training data set may be characterized by a number of features. By training the machine learning tool, the tool models or “learns” relationships between features of the data elements and the target variable or variables. Once trained, the machine learning tool can be used to predict the value of the target variable or variables for a given new input.

The accuracy and efficiency of the machine learning tool may depend on the relationship between the features provided to the tool and target of the tool. Typically, features are manually identified. For example, a practitioner may examine a data set and identify features expected to be predictive of a target based on experience or intuition. Such manual identification of features may be inefficient and labour-intensive. Moreover, manual identification may not yield the features most predictive of the target of the machine learning tool.

Accordingly, systems, methods, and devices for automatically generating and selecting features predictive of the target of the machine learning tool may therefore be desirable.

### SUMMARY

An example method of training a model for predicting a target characteristic of data elements comprises, at a processor: receiving an input data set comprising a plurality of data elements, the data elements characterized by a plurality of base features; automatically generating a plurality of synthetic features, each synthetic feature defined as a mathematical function of at least one existing feature or synthetic feature; for ones of the base features and the synthetic features, determining a feature score representative of a correlation with the target characteristic; selecting a filtered subset from the base features and the synthetic features based on the feature score values; providing the selected features to the machine learning tool; providing the input data set to the machine learning tool to generate the model.

An example system for training a model for predicting a target characteristic of data elements comprises: a processor; a computer-readable memory; computer-executable instructions in the memory for execution by the processor to cause the processor to: receive an input data set comprising a plurality of data elements, the data elements characterized by a plurality of base features; generate a plurality of synthetic features, each synthetic feature defined as a mathematical function of at least one existing feature or synthetic feature; for ones of the base features and the synthetic features, determine a feature score representative of a correlation with the target characteristic; select a filtered subset from the base features and the synthetic features based on the feature score values; train the model using the input data set and features of the filtered subset.

Other features will become apparent from the drawings in conjunction with the following description.

### BRIEF DESCRIPTION OF THE DRAWINGS

In the figures which illustrate example embodiments,

FIG. 1 is a network diagram illustrating a computer network and end-user computing devices connected to the network, exemplary of an embodiment;

FIG. 2 is a block diagram of a computing device of FIG. 1;

FIG. 3 is a block diagram showing example software organization of the computing device of FIG. 2;

FIG. 4A is a block diagram showing software modules of a feature definition tool of the computing device of FIG. 2;

FIG. 4B is a schematic diagram showing data structures at the computing device of FIG. 2; and

FIGS. 5-6 are flowcharts depicting exemplary blocks performed by the feature definition tool of the computing device of FIG. 2.

### DETAILED DESCRIPTION

Disclosed are systems, methods, and devices for training a machine learning tool by generating features and selecting predictive features from among a set of candidates. Features may be automatically generated by applying functions (e.g. transforming and combining) to previously identified features, thereby generating more complex features. A correlation between each feature and the target variable may be identified, and the features which correlate most strongly to the target may be provided to the machine learning tool for training and for predicting outcomes.

Features may be defined iteratively, and more complex features may be generated with repeated execution of the feature generation method. Thus, a large set of candidate features may be defined, including some synthetic features that are derived from previously-dentified features. At least some synthetic features may correlate with the target variable more strongly than the underlying features from which they are derived. A training set of features may be selected from among the candidate features for training the machine learning tool. The machine learning tool may, as a result of using more highly correlative features of the target variable, require less processing power to predict the target and may predict the target with more accuracy.

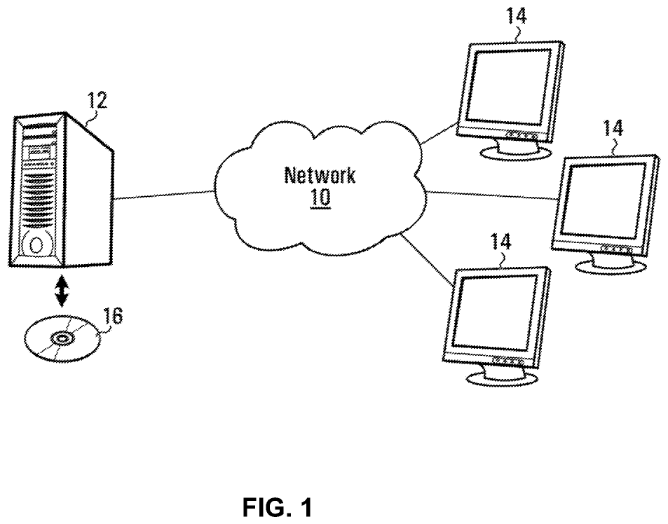

FIG. 1 illustrates a computer network 10, a network connected computing device 12, and network connected computing devices 14 exemplary of an embodiment. As will become apparent, computing device 12 includes software that facilitates automatic generation and selection of features for training a machine learning tool. Computing device 12 may be in communication with other computing devices such as computing devices 14 through computer network 10. Network 10 may be the public Internet, but could also be a private intranet. Computing devices 14 are network connected devices used to access data and services from computing device 12 and to provide data and services to computing device 12.

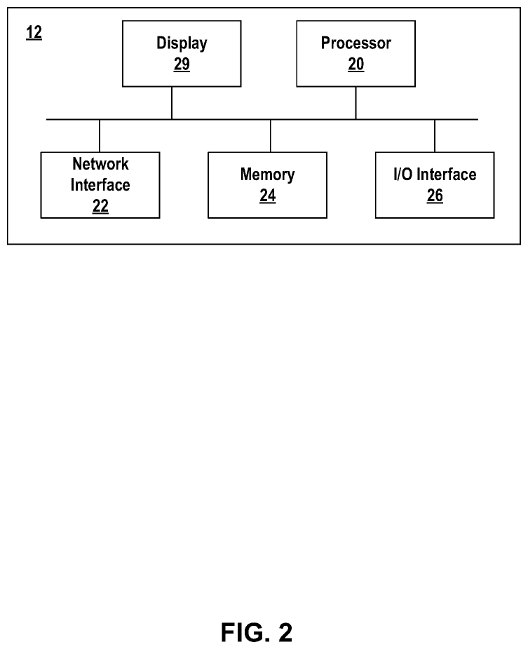

FIG. 2 is high-level block diagram of computing device 12. Computing device 12 includes one or more processors 20, a display 29, network interface 22, a suitable combination of persistent storage memory 24, random-access memory and read-only memory, and one or more I/O interfaces 26. Processor 20 may be an Intel x86, ARM processor, or the like. Network interface 22 connects device 12 to network 10. Memory 24 may be organized using any suitable filesystem, controlled and administered by an operating system governing overall operation of device 12. Device 12 may include input and output devices connected to device 12 by one or more I/O interfaces 26. These peripherals may include a keyboard and mouse. These peripherals may also include devices usable to load software to be executed at device 12 into memory 24 from a computer readable medium, such as computer readable medium 16 (FIG. 1).

Device 12 may store one or more data sets in memory 24, for example in a persistent data store. Each data set in memory 24 has a plurality of data elements. Each data element in a data set may be described by a number of characteristics associated with the data element.

By way of example, if each data element is an email message, each data element may be characterized by features, such as the date of the email, whether a reply was sent, whether the email includes a specific phrase, the email address of the sender, the domain associated with the email address of the sender, the email address(es) of the recipient(s), the subject line of the email, whether an attachment was enclosed, the size of the email or attachment and so forth.

Each characteristic of the email message may be quantified into one or more discrete numerical values. For example, the email address of the sender (and other non-numerical characteristics) may be hashed to generate a numerical value. Similarly, the value “1” may be used to indicate that an email message has an attachment, and the value “0” may be used to indicate that an email message has no attachment. Each quantifiable characteristic of a data element may be referred to as a “feature”.

Device 12 may also store one or more lists of features for each of the data sets in memory 24. Each feature in the list of features describes a characteristic of the data elements of a data set.

In some examples, features stored in memory 24 may be derived using functions to generate the values for each quantifiable characteristic of the data element. For example, a hash algorithm may be applied to the email address of a sender to generate a feature called “HASH(email_address_sender)”, where “email_address_sender” is a field of the data element (i.e. email message). Similarly, the list of features may include a feature called “ATTACHMENT( )” representing whether or not an email message has an attachment. Values for such a feature may be defined using a function having an output of “1” if the email message has an attachment and an output of “0” if there is no attachment.

Elements of a data set may be characterized by an initial list of features. The initial list of features may include, for example, features that are manually generated by an administrator of the machine learning tool 34 based on examination of the data set and target variable. The initial list may also include characteristics, e.g. data fields identified in the input data set. Such characteristics may be referred to as naturally occurring. For example, a user may identify the presence of an attachment to an email message as likely to be predictive of, or relevant to, whether the email message includes malicious code. The initial list of features may serve as a starting point from which computing device 12 may generate and select additional features for training a machine learning tool. Hereinafter, features of the initial list are referred to as “base features”.

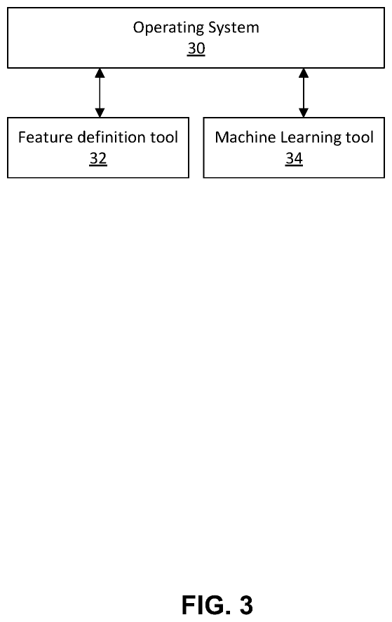

Device 12 may also store in memory 24 software code for automatic generation and selection of features for training a machine learning tool, as detailed below. FIG. 3 illustrates a simplified organization of example software components stored within memory 24 of device 12. The software components include operating system (OS) software 30, machine learning tool 34, and feature definition tool 32. Device 12 executes these software components to adapt it to operate in manners of embodiments, as detailed below.

OS software 30 may, for example, be a Unix-based operating system (e.g., Linux, FreeBSD, Solaris, Mac OS X, etc.), a Microsoft Windows operating system or the like. OS software 30 allows feature definition tool 32 to access processor 20, network interface 22, memory 24, and one or more I/O interfaces 26 of server 12. OS software 30 may include a network stack to allow device 12 to communicate with other computing devices, such as computing devices 14, through network interface 22.

Machine learning tool 34 may implement any number of machine learning algorithms (such as neural networks, support vector machines, decision trees, classifiers, and regression algorithms) to predict one or more target variables for a given input.

Machine learning tool 34 may be initialized using a labeled data set (referred to as “training”). As used herein, a “labeled” data set is a set of data elements with associated labels (e.g. as metadata) identifying a value of the target variable for each data element. For example, if the target is a binary value indicating whether a data element belongs to a certain group, the labeled data set includes data identifying which data elements belong to the group. The labeled data set may be stored in memory 24 and may have a number of features associated therewith. As will be explained further below, feature definition tool 32 may automatically generate additional features for the labeled data set stored in memory 24 to create a pool of candidate features from the pool. Such features may be referred to hereinafter as “synthetic features”. Feature definition tool 32, may automatically select the most predictive features, e.g. the features most strongly correlated to the labels, and provide those selected features to machine learning tool 34. The selected features include zero or more base features and zero or more synthetic features. If the selected features include synthetic features, the machine learning tool 34 may identify relationships between the synthetic features of the labeled data set and the target variable of the tool. Once trained, machine learning tool 34 may take as input a new data element and output a predicted outcome of the target variable.

Machine learning tool 34 may also include one more ensemble learning algorithms, which may utilize two or more sets of features to train two or more machine learning models. The trained machine learning models may be used concurrently to predict outcomes. In some embodiments, the ensemble learning algorithms provide a higher accuracy model than a single model.

Further, as will be apparent, users of device 12 or devices 14 may interact with feature definition tool 32, using a user-input device, to provide input parameters to control the operation of feature definition tool 32.

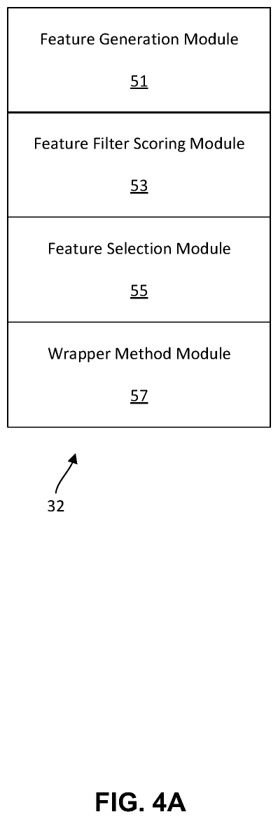

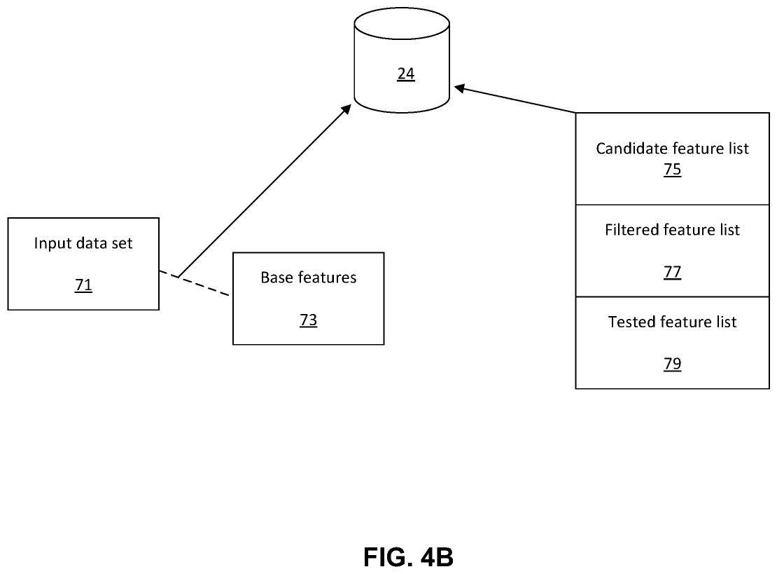

Feature definition tool 32 may include a number of modules, as illustrated in FIG. 4A. The modules of feature definition tool 32 may receive and produce data structures, as depicted in FIG. 4B. In the embodiment depicted in FIG. 4A, feature definition tool 32 includes a feature generation module 51, a feature scoring module 53, a feature selection module 55, and a wrapper identification module 57. These modules may be written using any suitable computing language such as C, C++, C#, Perl, JavaScript, Java, Visual Basic or the like. These modules may be in the form of executable applications, scripts, or statically or dynamically linkable libraries. The function of each of these modules is detailed below.

Feature generation module 51 includes methods for automated feature generation. Feature generation module 51 may receive a data set. Some features may be provided with or more occur naturally in data set 71, indicated in FIG. 4B as base features 73. Feature generation module 51 may store features in a data structure, referred to as a candidate feature list 75, shown in FIG. 4B. Candidate feature list 75 may include zero or more base features 73 and zero or more additional features derived by feature generation module 51, referred to as synthetic features. Feature generation module 51 transforms and combines existing features, which may be base features or synthetic features, to generate new features. The previously identified features 73 may be naturally occurring features in the data set (for example, the size of an attachment to an email). However, a naturally occurring feature may not be highly correlative of the target variable of the machine learning tool 34. On the other hand, synthetic features derived by feature generation module 51 may be more strongly related with the target variable than the underlying feature or features, although such relationship may not be apparent to a user or administrator of the tool 34. The level of difficulty increases with the complexity of the mathematical relationship of that synthetic feature to natural features. Nonetheless, some synthetic features are relatively highly correlative of the target variable of the machine learning tool 34. Thus, identifying highly correlative synthetic features, and then providing to machine learning tool 34 (for both training and predicting outcomes) may result in an improved accuracy of the tool and in reduced use of computing resources by the tool.

As will be explained in further detail, feature selection module 55 may select a subset of candidate feature list 75, referred to as filtered feature list 77. Wrapper module 57 may in turn select a subset of filtered feature list 77, referred to as tested feature list 79.

In some examples, feature generation module 51 may apply functions to derive synthetic features from existing or previously identified features. Such functions may include transformation operations, namely mathematical transformations of individual features, or combining operations, namely, operations which derive new features as a function of multiple existing features.

In some examples, transformation operations include exponential operations, e.g. obtaining the value of an existing feature to the power of 2, 3, 4 or 5 or −2, −3, −4 or −5.

In some examples, combining operations may include addition, subtraction, absolute difference, multiplication, division, minimum, maximum or average functions.

In some examples, the available functions for generating new features may be stored in a data structure in storage memory 24.

In some examples, feature generation module 51 may select one or more features from the list of features and apply a transformation operation, a combination operation, or both to generate new synthetic features. Feature generation module 51 may then add the synthetic feature to the candidate feature list.

As feature generation module 51 generates new features, feature generation module 51 may add those new features to the candidate feature list. Thus, the features listed in the list of features may include both natural features and synthetic features and feature generation module 51 may transform, combine, or transform and combine natural features or synthetic features. When feature generation module 51 generates new features using synthetic features as input, the generated features will have relatively complex mathematical relationships to the natural features. Further, as will become apparent, as feature generation module 51 is executed repeatedly, the number and complexity of synthetic features in the candidate feature list is likely to increase. The candidate feature list may have a maximum size, which may be a user-specified parameter. In some examples, feature generation module 51 may randomly select the features from which to generate synthetic features. Similarly, feature generation module 51 may select the transformation operations and combination operations randomly.

Examples of transformation operations which feature generation module 51 may apply include: no transformation, an exponentiation operation, a logarithmic operation, an antilogarithmic operation, and an inverse operation.

Examples of combination operations which feature generation module 51 may apply include: an addition operation, a subtraction operation, an absolute difference operation, a multiplication operation, a division operation, a minimum operation, a maximum operation, and an average operation.

Feature scoring module 53 is configured to determine feature scores for candidate features. The feature score of a feature may be representative of the degree of correlation between that feature and the target of machine learning tool 34. The degree of correlation between a feature and the target may be reflective of how predictive the feature is of the target, when used by machine learning tool 34. For example, if machine learning tool 34 is to identify data elements belonging to several categories, the score of a given candidate feature may give an approximate indication of how strongly predictive the candidate feature is of whether the data element belongs to a particular category.

Feature scoring module 53 may determine the feature score for features in the candidate feature list relatively quickly and at relatively low computational expense. However, the score provided only offers a rough guide at the effectiveness of a particular feature at predicting the target. For example, feature scoring module 53 does not account for the effect of using a particular feature together with other features.

Feature scoring module 53 and feature generation module 51 may be in communication with one another so that feature generation module 51 may provide feature scoring module 53 with the candidate feature list, including features generated by feature generation module 51.

In some examples, feature scoring module 53 determines the feature score of a particular feature by applying a statistical test to that feature. For example, feature scoring module 53 may apply any one or any number of statistical tests to the values representing the features in the labeled data set and the corresponding values of the target variable, including a Pearson's correlation test, a linear discriminant analysis test, an analysis of variance (“ANOVA”) test, and a chi-square test, amongst others.

For example, to perform a Pearson's correlation test for a particular feature, feature scoring module 53 may determine a value of that feature for each row in the input labeled data set. A correlation may then be computed between values of the feature and corresponding values of the target variable for each row.

Feature selection module 55 includes methods for selecting features from the list of features to provide to machine learning tool 34. Feature generation module 51 and feature selection module 55 may be in communication with one another so that feature generation module 51 may provide feature selection module 55 with a list of features, including features generated by feature generation module 51. Further, feature scoring module 53 may also be in communication with feature selection module 55 so that feature scoring module 53 may provide feature selection module 55 with scores for features in the list of features.

In some examples, feature selection module 55 selects a specific number of features that have the highest feature scores, to define filtered feature list 77. Feature selection module 55 provides the features of filtered feature list 77 to machine learning tool 34. The number of features selected may, for example, be a user-input parameter.

In other embodiments, feature selection module 55 selects features that have relatively high feature scores, as those features are expected to be highly predictive of the target of machine learning tool 34. Selecting features expected to be highly predictive and providing those highly predictive features to machine learning tool 34 (for both training and predicting outcomes) may result in an improved accuracy of the tool and in reduced use of computing resources by the tool.

In some examples, feature selection module 55 selects the features that have a feature score that is greater than a threshold value, and provides those selected features to machine learning tool 34. The threshold value may, for example, be a user-input parameter.

In some examples, features may be discarded (e.g. immediately discarded) based on low feature scores. For example, features may be discarded if they do not have a feature score higher than at least one parent feature. Additionally or alternatively, features may be discarded if they have feature scores below a defined threshold or below an average of the feature scores of the existing features.

In some examples, a user may be prompted for input defining a mode of operation of feature selection module 55. For example, a user may provide an input to control whether feature selection module 55 selects a specific number of features or features having a feature score above a threshold value.

Wrapper method module 57 includes methods for identifying a subset of tested features, selected from the filtered list of features 77, that are likely to be the most predictive of the target of machine learning tool 34. The filtered list of features 73 may be provided to wrapper method module 57 by feature selection module 55.

Wrapper method module 57 may iteratively select various subsets of features from the list of features provided thereto by feature selection module 55 and train a machine learning algorithm using those selected subsets of features. Wrapper method module 57 may determine a performance score of the machine learning algorithm for each subset of features. Wrapper method module 57 may then compare the performance of the machine learning algorithm for each subset of features, and provide the best performing subset of features to machine learning tool 34. In some examples, the wrapper method module 57 may employ the Boruta algorithm of feature selection. Other algorithms may be used, such as forward selection, backward elimination, and recursive feature elimination.

In some embodiments, wrapper method module 57 may identify the most predictive set of features for the machine learning algorithm implemented by machine learning tool 34. Further, in some embodiments, wrapper method module 57 may consider the relationship between various features, and omit redundant features. For example, although a feature may have a high feature score, it may be redundant as another feature maps a similar relationship to the target.

Wrapper method module 57 identifies at least some of the features of filtered feature list 77 to provide to machine learning tool 34 and thereby defines tested feature list 79 (FIG. 4B). Tested feature list 79 may typically be a relatively small subset of the features of filtered feature list 77. In some examples, the number of features selected by feature selection module 55 may be over 1,000 features, and the subset identified by wrapper method module 57 may include less than 100 features. As will be apparent, executing machine learning tool 34 using a relatively large number of features requires a relatively high processing power. Reducing the number of features using wrapper method module 57 is relatively less computationally expensive. Therefore, executing wrapper method module 57 first and then executing machine learning tool 34 using the tested feature list 79 may provide computational efficiency.

In some examples, feature selection module 55 may provide wrapper method module 57 with a list of features that have a feature score greater than a pre-defined threshold. In other words, only features that feature scoring module 53 identifies as highly correlative of the target variable are considered by wrapper method module 57. Executing wrapper method module 57 likely requires more processing power than feature scoring module 53. Thus, by limiting the number of features considered by wrapper method module 57, the overall processing required to select features predictive of the target of machine learning tool 34 may be reduced.

In some examples, wrapper method module 57 is only executed when the number of features in the filtered feature list 77 exceeds a threshold number. Accordingly, in some cases, wrapper method module 57 may be omitted and those features in filtered feature list 77 may be provided to machine learning tool 34. Machine learning tool 34 may then implement a model that takes into account all the features in filtered feature list 77. The threshold number of features for executing wrapper method module 57 may be defined such that omitting the wrapper method module, in some cases, may require less overall processing than executing wrapper method module 57 first.

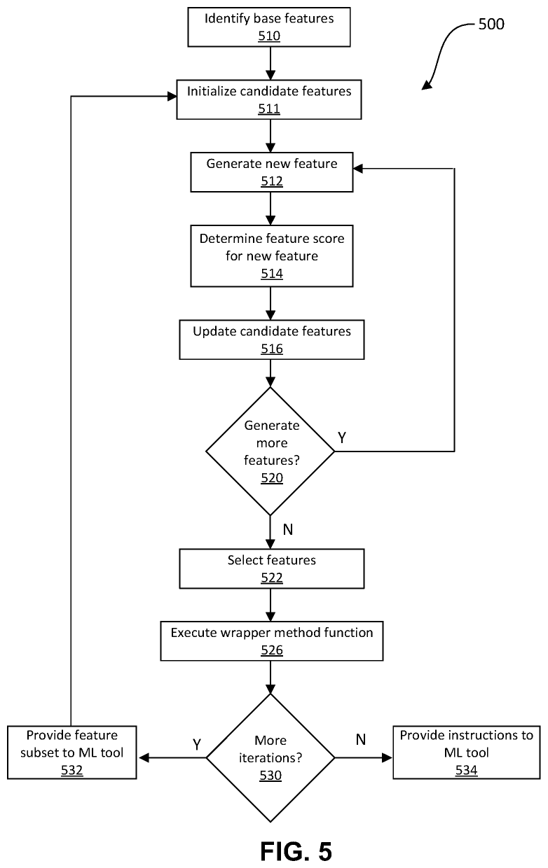

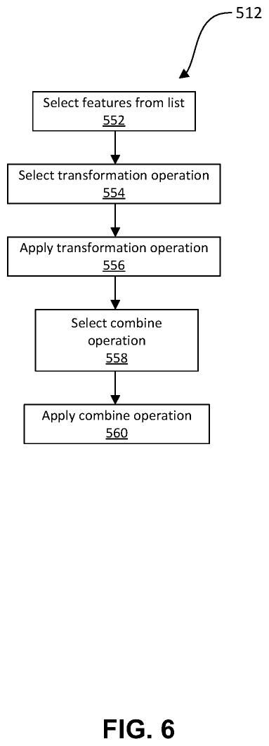

The operation of feature definition tool 32 is further described with reference to the example flowcharts illustrated in FIGS. 5-6.

FIGS. 5-6 illustrate an example method 500 for automatically generating and selecting features for training machine learning tool 34. Instructions for implementing method 500 are stored in memory 24, as part of feature definition tool 32. Method 500 may be performed by processor 20 of the computing device 12, operating under control of instructions provided by feature definition tool 32. Blocks of method 500 may be performed in-order or out-of-order, and processor 20 may perform additional or fewer steps as part of the method.

At 510, feature definition tool 32 may retrieve a data set and a list of features of the data set from memory 24. The list of features may include descriptions of features of the data set and may be referred to as base features. The descriptions may be represented as functions, for example, defining mathematical operations.

At 511 feature definition tool 32 may initialize a set of candidate features. For example, the set of candidate features may be set equal to the set of base features.

At 512, feature definition tool 32 may generate an additional feature for the data set. FIG. 6 illustrates an example method for generating additional features at 512. To generate an additional feature, feature definition tool 32 may, at 552, select one or more existing features from which to derive a new feature. The features from which a new feature is derived may be referred to as parent features. Feature definition tool 32 may select parent features randomly.

At 554, feature definition tool 32 may select one or more functions to be applied to the parent features. The functions may include one or both of transformation operations and combining operations. Feature definition tool 32 may select the transformation operation or operations randomly from among the available operations. For example, an operation may be selected randomly or according to a sequence from the data structure of available operations. Operations applied to each base feature may be selected independently of one another. Thus, different operations may be applied to each feature. Alternatively, operations of different features may be linked, such that the same operation is applied to multiple previously-identified features.

Once the features and transformation operation or operations are selected, at 556, feature definition tool 32 then applies the selected transformation operation or one of the selected transformation operations to those selected features.

To apply a transformation operation to a feature, feature definition tool 32 may transform the values that represent the features, and store the transformed values in memory. Furthermore, the transformed values may be labeled as such.

By way of example, if a selected transformation operation is the exponentiation to the power 2 operation and the base feature is the number of words in an email (e.g., 50), then feature definition tool 32 may raise the values to the power of 2, and store those values (e.g. 2500) as a separate feature.

Additionally or alternatively, feature definition tool 32 may select a combine operation, at 558, and apply the combine operation, at 560, to combine the two or more base features into a single additional feature. By way of example, a combine operation may be multiplying the values of the two or more transformed features by one another to generate a combined feature.

At 514, feature definition tool 32 determines a feature score for the additional feature, as described above. In some examples, feature definition tool 32 applies a filter method function to the additional feature to determine a degree of correlation between the addition feature and the target of machine learning tool 34.

At 516, feature definition tool 32 updates the list of candidate features. Specifically, feature definition tool 32 determines whether to add the additional feature to the list of features. By adding the additional feature to the list of features, feature definition tool 32 may then use that feature in generating further additional features. In some examples, feature definition tool 32 determines whether to add the additional feature to the list of features based on the feature score of that feature.

For example, feature definition tool 32 may only add the additional feature to the list of features if that feature's feature score is greater than a pre-defined threshold. By doing so, the average feature score of the features in the list of features may increase, after the addition of several additional features.

In another example, feature definition tool 32 may only add the additional feature to the list of features if that feature's score is greater the feature score of the parent features which were used to form the additional feature.

In some examples, when adding an additional feature to the list of features, feature definition tool 32 may also determine whether to remove a feature from the list of features. In one example, the number of features in the list of features may be limited to a pre-defined maximum. Once the list of features includes the maximum number of features, feature definition tool 32 may first remove a feature from the list of features before adding another. The feature removed from the list of features may be the feature having the lowest feature score. In another example, the feature removed from the list of features may be one or more of the parent features used to form the additional feature.

At 520, feature definition tool 32 determines whether to continue generating additional features. Feature definition tool 32 may continue generating additional features until the number of features in the list of features reaches a maximum number (which may be in the range of 1,000 to 5,000 features), or until a pre-defined number of additional features has been generated, or until a pre-defined run time has been reached (e.g. 1 hour run time). If so, processing returns to 512, and feature definition tool 32 generates additional features.

Once feature definition tool 32 determines to stop generating additional features, feature definition tool 32 proceeds to 522.

At 522, feature definition tool 32 selects features from the list of features that correlate relatively strongly with the target of machine learning tool 34. In this regard, feature definition tool 32 may select features from the list of features that have a feature score greater than a threshold score. Feature definition tool 32 may also select a defined number of features from the list of features that have the highest feature score (for example, the features which have the top ten scores). In some examples, at 522, feature definition tool 32 selects between 100 and 1,000 features.

Feature definition tool 32 executes the wrapper method function at 526 to identify a set of the selected features that is the most predictive of the target of machine learning tool 34. Feature definition tool 32 then stores the set of features and then proceeds to 530.

At 530, feature definition tool 32 determines whether to continue generating new features. Each time method 500 is executed, feature definition tool 32 may generate a unique set of features. For example, feature definition tool 32 may be programmed to run a pre-defined number of times to generate a pre-defined number of sets of features.

For example, the additional sets of features may be provided to machine learning tool 34, to allow machine learning tool 34 to run ensemble learning algorithms. In some embodiments, a user input may define the number of times a feature definition tool is run. For example, a user may be prompted to input a value at runtime.

If, at 530, feature definition tool 32 determines to continue generating new features, processing proceeds to 532.

At 532, feature definition tool 32 updates the list of features. The updated list of features will be used to generate the additional sets of features. In some examples, feature definition tool 32 updates the list of features to include only the subsets of features selected at 522 (i.e. the features having the highest feature scores) or the set of features identified at 526 (i.e. the set of features identified by the wrapper method function as being the most predictive).

Processing then returns to 511, where feature definition tool 32 may initialize the feature list and generate further additional features from the features in the updated list of features. Notably, since the updated list of features includes features that are more highly correlative with the target of machine learning tool 34 than the features in the initial list of features, the further additional features generated by feature definition tool 32 may have even higher feature scores and, as a result, be more predictive of the target.

If, at 530, feature definition tool 32 determines not to continue generating new features, processing proceeds to 534. At 534, feature definition tool 32 creates an ensemble from the feature sets generated during each execution of wrapper method function at 526. The ensemble is then provided to machine learning tool 34 for generation of a model. In some embodiments, feature definition tool 32 may run only a single time, in which case a single set of features may be provided to machine learning tool 34.

Of course, the above described embodiments are intended to be illustrative only and in no way limiting. The described embodiments are susceptible to many modifications of form, arrangement of parts, details and order of operation. For example, software (or components thereof) described at computing device 12 may be hosted at several devices. Software implemented in the modules described above could be implemented using more or fewer modules. The invention is intended to encompass all such modification within its scope, as defined by the claims.

What is claimed is:

1. A method of training a model for predicting a target characteristic of data elements, comprising, at a processor:
receiving an input data set comprising a plurality of data elements, said data elements characterized by a plurality of base features;
automatically generating a plurality of synthetic features, each synthetic feature defined as a mathematical function of at least one existing feature or synthetic feature;
for ones of said base features and said synthetic features, determining a feature score representative of a correlation with said target characteristic;
selecting a filtered subset from said base features and said synthetic features based on said feature score values;
providing the selected features to the machine learning tool;
providing said input data set to said machine learning tool to generate said model.

2. The method of claim 1, further comprising selecting a tested subset of said filtered subset, based on testing performance a machine learning model trained with groups of said features.

3. The method of claim 2, wherein said testing performance comprises:
applying a wrapper method function to said filtered subset of features wherein the wrapper method function:
trains a machine learning algorithm using groups of features from said filtered subset;
determines a performance of said trained machine learning algorithm trained with each group of features for predicting said target of said machine learning tool; and
identifying a tested subset from said filtered subsets, said first subset having the highest performance; and
providing the features of the first subset to the machine learning tool.

4. The method of claim 3, further comprising:
selecting a second subset from the subsets of features; and
providing the first and second subsets to an ensemble learning function.

5. The method of claim 1, wherein synthetic features are derived from randomly-selected ones of said base features.

6. The method of claim 1, wherein generating an additional feature comprises:
selecting a first transformation operation, said first transformation operation for mathematically deriving values from a first existing feature;
applying the first transformation operation to a first feature;
selecting a combination operation; and
applying the combination operation to combine the result of said first transformation operation with another feature.

7. The method of claim 6, wherein said first transformation operation is selected randomly from a list defining available operations.

8. The method of claim 7, wherein said combination operation is selected randomly.

9. The method of claim 1, comprising automatically generating synthetic features for a fixed period of time.

10. The method of claim 1, comprising automatically generating a preset number of said synthetic features.

11. A system for training a model for predicting a target characteristic of data elements, comprising:
a processor;
a computer-readable memory;
computer-executable instructions in said memory for execution by said processor to cause said processor to:
receive an input data set comprising a plurality of data elements, said data elements characterized by a plurality of base features;
generate a plurality of synthetic features, each synthetic feature defined as a mathematical function of at least one existing feature or synthetic feature;
for ones of said base features and said synthetic features, determine a feature score representative of a correlation with said target characteristic;
select a filtered subset from said base features and said synthetic features based on said feature score values;
train said model using said input data set and features of said filtered subset.

12. The system of claim 11, wherein said instructions further cause said processor to select a tested subset of said filtered subset, based on testing performance a machine learning model trained with groups of said features.

13. The system of claim 12, wherein said testing performance comprises:
applying a wrapper method function to said filtered subset of features wherein the wrapper method function:
trains a machine learning algorithm using groups of features from said filtered subset;
determines a performance of said trained machine learning algorithm trained with each group of features for predicting said target of said machine learning tool; and
identifying a tested subset from said filtered subsets, said first subset having the highest performance; and
providing the features of the first subset to the machine learning tool.

14. The system of claim 13, wherein said instructions further cause said processor to:
select a second subset from the subsets of features; and
provide the first and second subsets to an ensemble learning function.

15. The system of claim 11, wherein said instructions cause said processor to derive said synthetic features from randomly-selected ones of said base features.

16. The system of claim 11, wherein said instructions cause said processor to generate an additional feature by:
selecting a first transformation operation, said first transformation operation for mathematically deriving values from a first existing feature;
applying the first transformation operation to a first feature;
selecting a combination operation; and
applying the combination operation to combine the result of said first transformation operation with another feature.

17. The system of claim 16, wherein said first transformation operation is selected randomly from a list defining available operations.

18. The system of claim 17, wherein said combination operation is selected randomly from said list defining available operations.

19. The system of claim 11, wherein said instructions cause said processor to generate synthetic features for a fixed period of time.

20. The method of claim 11, wherein said instructions cause said processor to generate a preset number of said synthetic features.
